(19) United States
(12) Patent Application Publication
(10) Pub. No.: US 2007/0042256 A1
(43) Pub. Date: Feb. 22, 2007

(54) Gas crossover barrier with electrochemical conversion cell membrane

(76) Inventor: Seth D. Valentine, Oklahoma City, OK (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/206,582

(22) Filed: Aug. 18, 2005

(51) Int. Cl. H01M 2/08; H01M 8/10

(52) U.S. Cl. 429/36; 429/30; 29/623.2

(57) ABSTRACT

A device is provided comprising at least one electrochemical conversion cell configured to convert first and second reactants to electrical energy. The electrochemical conversion cell comprises a membrane electrode assembly defining a partition between first and second reactant supplies. The membrane electrode assembly comprises a polymer electrolyte membrane configured to conduct protons. The polymer electrolyte membrane defines a peripheral edge portion along the perimeter of the membrane and an interior region bounded by the peripheral edge portion. A gas crossover barrier material is bonded to the polymer electrolyte membrane along a majority of the peripheral edge portion. A process of bonding the barrier material to the membrane is also provided.

### BACKGROUND OF THE INVENTION

The present invention relates to electrochemical conversion cells, commonly referred to as fuel cells, which produce electrical energy by processing first and second reactants, e.g., through oxidation and reduction of hydrogen and oxygen. By way of illustration and not limitation, a typical cell comprises a membrane electrode assembly positioned between a pair of gas diffusion media layers. A cathode flow field plate and an anode flow field plate are positioned on opposite sides of the cell unit, adjacent the gas diffusion media layers. The voltage provided by a single cell unit is typically too small for useful application. Accordingly, a plurality of cells are typically arranged and connected consecutively in a “stack” to increase the electrical output of the electrochemical conversion assembly or fuel cell.

### BRIEF SUMMARY OF THE INVENTION

The present invention is directed to addressing performance issues attributable to membranes and associated components utilized in membrane electrode assemblies of electrochemical conversion cells. In accordance with one embodiment of the present invention, a device is provided comprising at least one electrochemical conversion cell configured to convert first and second reactants to electrical energy. The electrochemical conversion cell comprises a membrane electrode assembly defining a partition between first and second reactant supplies. The membrane electrode assembly comprises a polymer electrolyte membrane configured to conduct protons. The polymer electrolyte membrane defines a peripheral edge portion along the perimeter of the membrane and an interior region bounded by the peripheral edge portion. A gas crossover barrier material is bonded to the polymer electrolyte membrane along a majority of the peripheral edge portion. The interior region of the membrane is characterized by a relatively low amount of the gas crossover barrier material.

In accordance with another embodiment of the present invention, a process is provided where a polymer electrolyte membrane is provided and defines a peripheral edge portion along a perimeter of the membrane and an interior region bounded by the peripheral edge portion. A gas crossover barrier material is bonded to the polymer electrolyte membrane along a majority of the peripheral edge portion such that the interior region of the membrane is characterized by a relatively low amount of the gas crossover barrier material.

Accordingly, it is an object of the present invention to address performance issues attributable to membranes and associated components utilized in membrane electrode assemblies of electrochemical conversion cells. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is an exploded illustration of an electrochemical conversion cell according to one embodiment of the present invention; and

FIG. 2 is an illustration of a vehicle incorporating an electrochemical conversion cell according to the present invention.

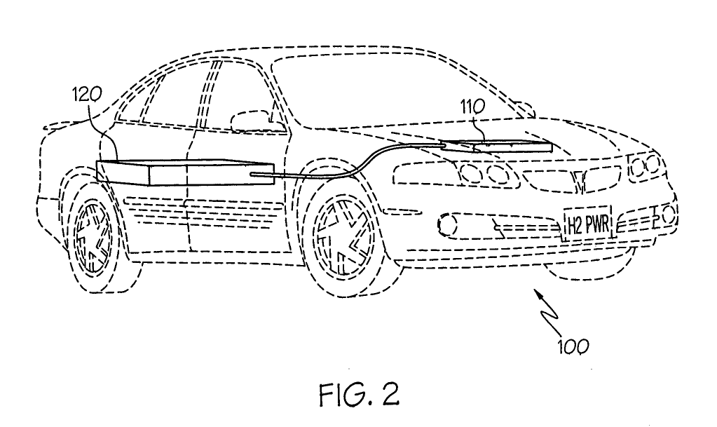

### DETAILED DESCRIPTION

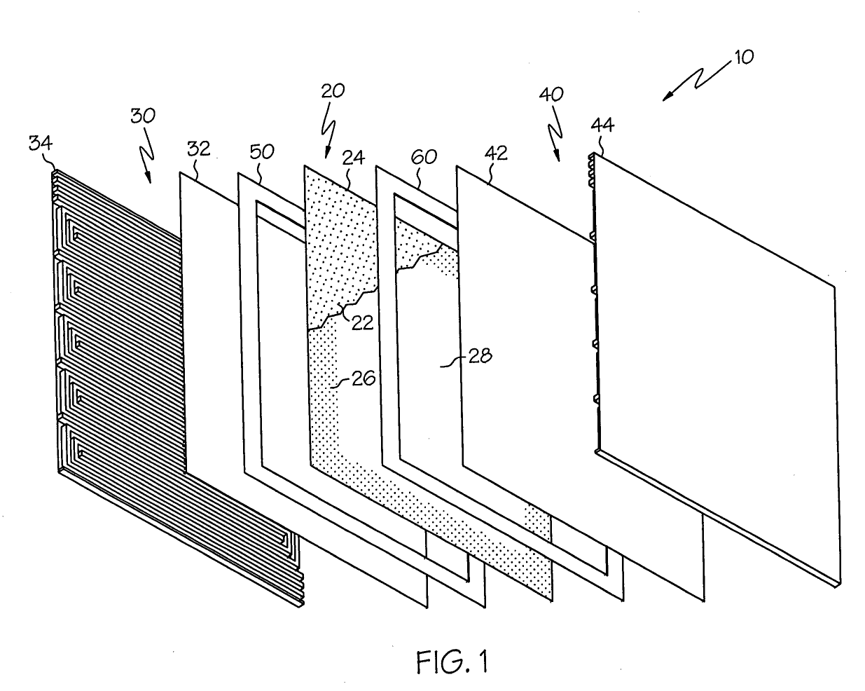

Referring to the exploded view of FIG. 1, noting that the general construction and operation of electrochemical conversion cells are beyond the scope of the present invention and may be gleaned from any suitable source covering electrochemical conversion cells, some typical components of an electrochemical conversion cell 10 are illustrated. Specifically, and not by way of limitation, an electrochemical conversion cell 10 according to the present invention is configured to convert first and second reactants R₁, R₂, to electrical energy. The illustrated cell 10 comprises a membrane electrode assembly 20 and first and second flowfield portions 30, 40 disposed on opposite sides of the membrane electrode assembly 20. Respective peripheral gaskets 50, 60 are disposed between the first and second flowfield portions 30, 40 and the opposite sides of the membrane electrode assembly 20.

Although the present invention is not limited to a particular class of membrane electrode assemblies, for the purposes of illustration, it is noted that typical membrane electrode assemblies 20 comprises a first catalytic electrode 22, shown partially in FIG. 1, formed on a first surface of a proton conducting polymer electrolyte membrane 24 and a second catalytic electrode formed on a second, reverse surface of the polymer electrolyte membrane 24. The first catalytic electrode 22 is in communication with the first reactant supply R₁ while the second catalytic electrode is in communication with the second reactant supply R₂. Polymer electrolyte membranes are widely used in electrochemical conversion cells because they conduct protons efficiently and possess low fuel crossover properties—defining a suitable partition between reactant supplies. They are also robust enough to be assembled into a fuel cell stack and have relatively long life. One of the most common types of polymer electrolyte membranes is NAFION®, a perfluorosulfonate ionomer membrane material available from DuPont that is widely used in electrochemical conversion cells where the first reactant R₁ is a hydrogenous fuel source and the second reactant R₂ comprises oxygen or air.

As is illustrated in FIG. 1, a gas crossover barrier material 26 is bonded to the polymer electrolyte membrane 24 along a peripheral edge portion of the membrane 24. Although the present invention is not limited to specific advantages associated with the use of the barrier material 26, generally, the role of the gas crossover barrier material is to stabilize the membrane by reducing the degree to which crossover of reactant gases affect operaton of the electrochemical conversion cell 10. It is believed that the degree of crossover is reduced because the gas crossover barrier material 26 functions to inhibit the formation of a substantial number of pinholes in the membrane 24 during assembly and/or operation of the cell 10.

The interior region 28 of the membrane 24 is substantially free of the gas crossover barrier material 26, or is at least characterized by a relatively low amount of the gas crossover barrier material 26. Although not required, the area of the peripheral edge portion occupied by the gas crossover barrier material 26 is large enough to accommodate the peripheral gaskets 50, 60 in the assembled configuration. Peripheral edge portions of the first and second catalytic electrodes may overlie the gas crossover barrier material 26, as is illustrated, underlie the barrier material 26, or be intermingled with the barrier material 26.

In some embodiments of the present invention, it may be preferable to ensure that the gas crossover barrier material 26 penetrates the polymer electrolyte membrane 24. The gas crossover barrier material 26 may penetrate a portion, or substantially all, of the thickness dimension of the polymer electrolyte membrane 24. The gas crossover barrier material 26 may comprise a material having sufficient viscosity when uncured to enhance penetration prior to curing.

In other embodiments of the present invention, it may be preferable to ensure that the gas crossover barrier material 26 is bonded to the polymer electrolyte membrane 24 in a manner that introduces no more than a negligible increase in a thickness dimension of the peripheral edge portion of the membrane 24. It is contemplated that this result may be accomplished through penetration or otherwise. By way of example, the thickness dimension of the membrane 24 is less than about 0.35 mm and the negligible increase in the thickness dimension is less than about 0.03 mm. Alternatively, the increase in thickness may be quantified as a percentage, e.g., no more than 5%, of the thickness dimension of the peripheral edge portion of the membrane 24.

In still other embodiments of the present invention, the gas crossover barrier material 26 may be selected and configured such that it introduces negligible changes in the compressibility of the membrane 24 and exhibits cross-linking upon curing. Further, to enhance the stability of the gas crossover barrier material 26 during operation of the cell 10, the material can be selected such that it cures below the operating temperature of the cell 10. For example, where the operating temperature of the cell is about 60° C., the gas crossover barrier material 26 can be selected such that it cures below about 60° C. To provide some margin for error, the gas crossover barrier material 26 can be selected such that it cures significantly below the operating temperature of the cell 10, e.g., below about 50° C.

Suitable gas crossover barrier materials may exhibit one or more of the characteristics described below. Specifically, the material may be a one-part, flowable material of sufficient viscosity to penetrate the membrane material. Further, the material may be presented as a solvent-free material that cures at or near room temperature. The material should exhibit good adhesion to the particular membrane materials in use. The material may be selected to exhibit stability and structural flexibility over a wide temperature range, or at least the operating temperature range of the device in which it is to be incorporated. The material may also be selected such that it exhibits excellent dielectric properties. For example, and not by way of limitation, solvent free room temperature vulcanizing silicone rubber products, such as DOW CORNING 3140, or fluoropolymer resins that exhibit cross-linking upon curing and cure at workable temperatures, such as polyvinylidene fluoride, are suitable candidates.

In the illustrated embodiment, the flowfield portions 30, 40 comprise gas diffusion media layers 32, 42 and respective flow field plates 34, 44. The flowfield portions 30, 40 and gas diffusion media layers 32, 42 enhance the delivery of reactants to the associated cells. As will be appreciated with those practicing the present invention, the concepts of the present invention are not limited to cell configurations including flow field portions of the nature illustrated in FIG. 1.

Referring to FIG. 4, a device according to the present invention may comprise a vehicle 100 and an electrochemical conversion assembly 110 according to the present invention. The electrochemical conversion assembly 110 can be configured to at least partially provide the vehicle 100 with motive power. The vehicle 100 may also have a fuel processing system or fuel source 120 configured to supply the electrochemical conversion assembly 110 with fuel.

Although the present invention is not limited to any specific reactant compositions, it will be appreciated by those practicing the present invention and generally familiar with fuel cell technology that the first reactant supply R₁ typically comprises oxygen and nitrogen while the second reactant supply R₂ comprises hydrogen.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims, where the claim term “wherein” is utilized in the open-ended sense. More specifically, although some aspects of the present invention are identified herein as preferred or particularly advantageous, it is contemplated that the present invention is not necessarily limited to these preferred aspects of the invention.

What is claimed is:

1. A device comprising at least one electrochemical conversion cell configured to convert first and second reactants to electrical energy, said electrochemical conversion cell comprising a membrane electrode assembly defining a partition between first and second reactant supplies, said membrane electrode assembly comprising a polymer electrolyte membrane configured to conduct protons, wherein:
said polymer electrolyte membrane defines a peripheral edge portion along the perimeter of said membrane and an interior region bounded by said peripheral edge portion;
a gas crossover barrier material is bonded to said polymer electrolyte membrane along a majority of said peripheral edge portion; and
said interior region of said membrane is characterized by a relatively low amount of said gas crossover barrier material.

2. A device as claimed in claim 1 wherein said interior region of said membrane is substantially free of said gas crossover barrier material.

3. A device as claimed in claim 1 wherein said gas crossover barrier material is bonded to said polymer electrolyte membrane in a manner that introduces no more than a negligible increase in a thickness dimension of said peripheral edge portion of said membrane.

4. A device as claimed in claim 3 wherein said thickness dimension of said membrane is less than about 0.35 mm and said negligible increase in said thickness dimension is less than about 0.03 mm.

5. A device as claimed in claim 1 wherein said gas crossover barrier material is bonded to said polymer electrolyte membrane in a manner that introduces no more than a 5% increase in a thickness dimension of said peripheral edge portion of said membrane.

6. A device as claimed in claim 1 wherein said gas crossover barrier material is selected and configured such that it introduces negligible changes in the compressibility of said membrane.

7. A device as claimed in claim 1 wherein said gas crossover barrier material penetrates a substantial portion of a thickness dimension of said polymer electrolyte membrane.

8. A device as claimed in claim 1 wherein said gas crossover barrier material penetrates a thickness dimension of said polymer electrolyte membrane substantially entirely.

9. A device as claimed in claim 1 wherein said gas crossover barrier material comprises a material having sufficient viscosity when uncured to penetrate a thickness dimension of said polymer electrolyte membrane.

10. A device as claimed in claim 9 wherein said gas crossover barrier material that exhibits cross-linking upon curing.

11. A device as claimed in claim 9 wherein said gas crossover barrier material cures at a temperature below the operating temperature of said electrochemical conversion cell.

12. A device as claimed in claim 1 wherein said gas crossover barrier material comprises a solvent free room temperature vulcanizing silicone rubber.

13. A device as claimed in claim 1 wherein said gas crossover barrier material comprises silicone.

14. A device as claimed in claim 1 wherein said gas crossover barrier material comprises polyvinylidene fluoride.

15. A device as claimed in claim 1 wherein said gas crossover barrier material comprises a fluoropolymer resin that exhibits cross-linking upon curing and cures at a temperature below about 60° C.

16. A device as claimed in claim 1 further comprising:
a first catalytic electrode formed on a first surface of said polymer electrolyte membrane in communication with said first reactant supply; and
a second catalytic electrode formed on a second surface of said polymer electrolyte membrane in communication with said second reactant supply.

17. A device as claimed in claim 16 wherein portions of said first and second catalytic electrodes overlie said gas crossover barrier material.

18. A device as claimed in claim 1 further comprising a first and second flowfield portions, wherein:
said first and second flowfield portions are disposed on opposite sides of said polymer electrolyte membrane;
respective peripheral gaskets are disposed between said first and second flowfield portions and said opposite sides of said membrane; and
said peripheral edge portion defined by said gas crossover barrier material is at least large enough to accommodate said peripheral gaskets.

19. A device as claimed in claim 1 wherein said device further comprises a vehicle and said electrochemical conversion cell serves as a source of motive power for said vehicle.

20. A device comprising at least one electrochemical conversion cell configured to convert first and second reactants to electrical energy, said electrochemical conversion cell comprising a membrane electrode assembly defining a partition between first and second reactant supplies, said membrane electrode assembly comprising a polymer electrolyte membrane configured to conduct protons, wherein:
a first catalytic electrode is formed on a first surface of said polymer electrolyte membrane in communication with said first reactant supply;
a second catalytic electrode is formed on a second surface of said polymer electrolyte membrane in communication with said second reactant supply;
portions of said first and second catalytic electrodes overlie said gas crossover barrier material;
first and second flowfield portions are disposed on opposite sides of said polymer electrolyte membrane;
respective peripheral gaskets are disposed between said first and second flowfield portions and said opposite sides of said membrane;
said polymer electrolyte membrane defines a peripheral edge portion along the perimeter of said membrane and an interior region bounded by said peripheral edge portion;
a gas crossover barrier material is bonded to said polymer electrolyte membrane along a majority of said peripheral edge portion;
said peripheral edge portion occupied by said gas crossover barrier material is at least large enough to accommodate said peripheral gaskets.
said gas crossover barrier material is bonded to said polymer electrolyte membrane in a manner that introduces no more than a negligible increase in a thickness dimension of said peripheral edge portion of said membrane;
said gas crossover barrier material is selected and configured such that it introduces negligible changes in the compressibility of said membrane;
said gas crossover barrier material penetrates a thickness dimension of said polymer electrolyte membrane substantially entirely; and
said gas crossover barrier material that exhibits cross-linking upon curing and cures at a temperature below the operating temperature of said electrochemical conversion cell.

21. A process comprising:
providing a polymer electrolyte membrane defining a peripheral edge portion along a perimeter of said membrane and an interior region bounded by said peripheral edge portion; and
bonding a gas crossover barrier material to said polymer electrolyte membrane along a majority of said peripheral edge portion, wherein said interior region of said membrane is characterized by a relatively low amount of said gas crossover barrier material.

22. A process as claimed in claim 21 wherein said gas crossover barrier material is bonded to said polymer electrolyte membrane through a silk screening process.

23. A process as claimed in claim 21 wherein said gas crossover barrier material is bonded to said polymer electrolyte membrane in a pattern defining a frame about said peripheral edge portion of said membrane.

24. A process as claimed in claim 21 wherein said gas crossover barrier material is bonded to said polymer electrolyte membrane with the aid of a vacuum draw through a thickness of said membrane.

25. A process as claimed in claim 1 further comprising the step of assembling an electrochemical conversion cell including said polymer electrolyte membrane.
